(19) United States
(12) Patent Application Publication
(10) Pub. No.: US 2017/0162075 A1
(43) Pub. Date: Jun. 8, 2017

(54) SYSTEM AND METHOD FOR ANALYZING INGESTION OF DIET

(71) Applicant: INDUSTRIAL TECHNOLOGY RESEARCH INSTITUTE, Hsinchu Hsien (TW)

(72) Inventors: Zhong-Wei LIAO, Kaohsiung City (TW); Jian-Hong LIU, Kaohsiung City (TW); Ho-Hsin LEE, Hsinchu City (TW); Yue-Min JIANG, New Taipei City (TW); Tsai-Ya LAI, New Taipei City (TW)

(73) Assignee: INDUSTRIAL TECHNOLOGY RESEARCH INSTITUTE, Hsinchu Hsien (TW)

(21) Appl. No.: 14/980,115

(22) Filed: Dec. 28, 2015

(30) Foreign Application Priority Data
Dec. 4, 2015 (TW) 104140805

(51) Int. Cl. G09B 19/00

(52) U.S. Cl. CPC G09B 19/0092

(57) ABSTRACT

A diet ingestion analyzing method is provided. The diet ingestion analyzing method includes the following steps. A plurality of nutrition amounts of a plurality of diet records are calculated according to a food nutrition database. A plurality of specific diet records corresponding a specific time are obtained from the diet records. A nutrition ingestion ratio of a total of a plurality of nutrition amounts of the specific diet records to a total of the nutrition amounts of the diet records is generated. A nutrition recommendation is generated according to a nutrition recommended range and the nutrition ingestion ratio. A plurality of selected records is selected from the specific diet records. Whether each of a plurality of nutrition amounts of the selected records is abnormal or not is determined according to the nutrition recommendation. A diet model is constructed and an abnormal food is marked according to the selected records.

The disclosure relates in general to a diet ingestion analyzing system and a diet ingestion analyzing method.

### BACKGROUND

Chronic condition is known as lifestyle diseases in Japanese. It is because the chronic condition including the hypertension, heart disease, diabetes or cancer is strongly related to life style. Research by Taiwan Food and Drug Administration, Ministry of Health and Welfare discloses that with the patients with chronic diseases increases every year, 70 percent of the top ten cause of death is chronic condition, and the control and management of the chronic condition becomes the major concern for public's health. Therefore, the course of chronic disease may be delayed or improved by guiding and adjusting the eating habits of the user. Thus, in order to prevent from the chronic condition or to keep in good health, it is necessary to observe the eating types of a person and to help controlling the person's diet. The traditional diet managing method is to record the diet records of the person and to controll diet according to the nutrition recommendation suggested by a dietitian or a doctor. However, the traditional diet managing method may not be adjusted according to personal eating habits and the traditional diet managing method does not analyze the food causing exceeding the nutrition amounts of the personal diet, and it is not convenient for the dietitian or the doctor to provide dietary suggestion according to personal eating habits. As a result, it is needed to provide a method and a system for constructing a personal diet model and marking an abnormal food according to personal diet record.

### SUMMARY

According to one embodiment, a diet ingestion analyzing system is provided. The diet ingestion analyzing system includes a diet nutrition converting unit, a nutrition ingestion ratio distributing unit, a nutrition ingestion abnormality marking unit, and a diet model constructing unit. The diet nutrition converting unit calculates a plurality of nutrition amounts corresponding to a plurality of diet records according to the plurality of diet records and a food nutrition database. Each of the diet records comprises an eating time point, a food and a quantity of the food. The ratio nutrition ingestion calculating unit obtains a plurality of specific diet records corresponding a specific time from the diet records according to the eating time points of the diet records. The nutrition ingestion nutrition ingestion ratio distributing unit generates a nutrition ingestion ratio of a total of a plurality of nutrition amounts of the specific diet records to a total of the nutrition amounts of the diet records. The nutrition ingestion ratio distributing unit further generates a nutrition recommendation according to a nutrition recommended range and the nutrition ingestion ratio. The nutrition ingestion abnormality marking unit selects a plurality of selected records from the plurality of specific diet records. The nutrition ingestion abnormality marking unit determines whether each of a plurality of nutrition amounts of the selected records is abnormal or not according to the nutrition recommendation. The diet model constructing unit constructs a diet model and marks an abnormal food according to the selected records and whether the nutrition amounts of each of the selected records is abnormal or not.

According to another embodiment, a diet ingestion analyzing method is provided. The diet ingestion analyzing method includes the following steps. A plurality of nutrition amounts of a plurality of diet records corresponding to a plurality of diet records are calculated according to the plurality of diet records and a food nutrition database. Each of the diet records comprises an eating time point, a food and a quantity of the food. A plurality of specific diet records corresponding a specific time are obtained from the diet records according to the eating time points of the diet records. A nutrition ingestion ratio of a total of a plurality of nutrition amounts of the specific diet records to a total of the nutrition amounts of the diet records is generated. A nutrition recommendation is generated according to a nutrition recommended range and the nutrition ingestion ratio. A plurality of selected records are selected from the specific diet records. Whether each of a plurality of nutrition amounts of the selected records is abnormal or not is determined according to the nutrition recommendation. A diet model is constructed and an abnormal food is marked according to the selected records and whether the nutrition amounts of each of the selected records is abnormal or not.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a diet ingestion analyzing system according to an embodiment of the disclosure.

FIGS. 2A to 2F are schematic diagrams of constructing the diet model according to a plurality of diet records in a table 2 of the disclosure.

FIG. 3 is a block diagram of a diet ingestion analyzing system according to another embodiment of the disclosure.

FIGS. 4A and 4B are schematic diagram of an example for deciding a plurality of dining time periods according to a plurality of diet records in each hour.

FIG. 4C is a schematic diagram of an example for deciding a specific time according to the diet records in each hour.

FIG. 5 is a flowchart of a diet ingestion analyzing method.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

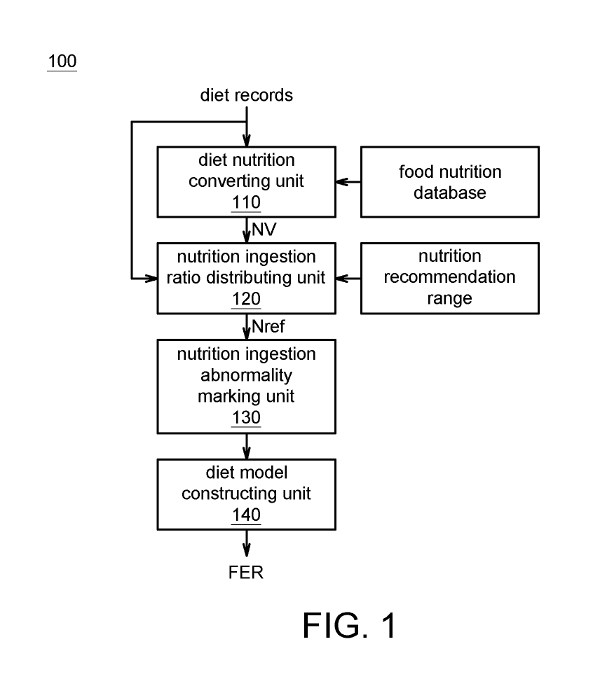

FIG. 1 is a block diagram of a diet ingestion analyzing system 100 according to an embodiment of the disclosure. The diet ingestion analyzing system 100 includes a diet nutrition converting unit 110, a nutrition ingestion ratio distributing unit 120, a nutrition ingestion abnormality marking unit 130, and a diet model constructing unit 140. The diet nutrition converting unit 110 correspondingly calculates a plurality of nutrition amounts NV of a plurality of diet records according to the plurality of diet records and a food nutrition database. The nutrition ingestion ratio distributing unit 120 obtains a plurality of specific diet records corresponding a specific time from the diet records according to the eating time points of the diet records, and generates a nutrition ingestion ratio of a total of a plurality of nutrition amounts of the specific diet records to a total of the nutrition amounts of the diet records. The nutrition ingestion ratio distributing unit 120 further generates a nutrition recommendation in the specific time Nref according to a nutrition recommended range and the nutrition ingestion ratio. The nutrition ingestion abnormality marking unit 130 selects a plurality of selected records from the specific diet records and determines whether each of a plurality of nutrition amounts of the selected records in the specific time is abnormal or not according to the nutrition recommendation in the specific time. The diet model constructing unit 140 constructs a diet model and marks an abnormal food FER according to the selected records and whether the nutrition amounts of each selected record is abnormal or not.

For example, the diet ingestion analyzing system 100 may be implemented by a computer or software. The diet ingestion analyzing system 100 may receive a plurality of diet records inputted or selected by the user, and may generate a diet model and mark an abnormal food accordingly. Each of the diet records includes an eating time point, a food and a quantity of the food. For instance, a diet record of the breakfast on August 1 may be recorded as “eating time point: 8/1 8:20, food and quantity: one bread and one glass of milk.” The diet nutrition converting unit 110 calculates the nutrition amounts NV of each of the diet records according to each of the diet records and the food nutrition database. The food nutrition database may be the database provided by Taiwan Food and Drug Administration, Ministry of Health and Welfare. The food nutrition database may include a table showing various foods and the multiple nutrition corresponding to each food, e.g. the calories, water, protein, fat, carbohydrate, vitamin, and mineral of one papaya. The food nutrition database may also be established by the user. In this embodiment, the diet nutrition converting unit 110 may calculate the nutrition amounts of carbohydrate. However, the disclosure is not limited thereto, and the diet nutrition converting unit 110 may calculate other types of nutrition.

Afterwards, the nutrition ingestion ratio distributing unit 120 selects or inputs a specific time, e.g. breakfast time or 8:00-12:00 A.M., to obtain the specific diet records from the diet records, the eating time point of which is in the specific time, such as the diet record in breakfast. The nutrition ingestion ratio distributing unit 120 sums up all of the nutrition amounts of the specific diet records, i.e. all of the nutrition amounts of the diet records in breakfast. Then the nutrition ingestion ratio distributing unit 120 obtains a nutrition ingestion ratio in breakfast according to a total of the nutrition amounts of the specific diet records in breakfast and a total of the nutrition amounts of all diet records. In an embodiment, the nutrition ingestion ratio distributing unit 120 further calculates a trimmed mean of the nutrition amounts of each of the dining time periods to discard the extreme value, and obtains each of the nutrition ingestion ratio of the dining time periods according to each of the trimmed mean of the nutrition amounts of the dining time periods and the trimmed mean of the nutrition amounts of all of the diet records. For example, NRi=μₜᵣᵢₘ (ᵢ)/μₜᵣᵢₘ (ₜₒₜₐₗ), where i is a positive integer from 0 to the number of dinning time, where μₜᵣᵢₘ (ᵢ) is the trimmed mean of the nutrition amounts of the ith dinging time periods, and μₜᵣᵢₘ (ₜₒₜₐₗ) is the trimmed mean of the nutrition amounts of all of the diet record, and NRi is the nutrition ingestion ratio of each of the dinning time. However, the disclosure is not limited thereto, the nutrition ingestion ratio distributing unit 120 may use all kinds of statistics method to calculate the average of the nutrition amounts of each of the dining time periods and the average of the nutrition amounts of all diet records, and obtain the nutrition ingestion ratio by dividing the average of the nutrition amounts of each of the dining time periods and the average of the nutrition amounts of all of the diet records. Therefore, the nutrition ingestion ratio distributing unit 120 may calculate the nutrition ingestion ratio of carbohydrate ingestion in each dining time period according to the nutrition amounts of each of the dining time periods and the nutrition amounts of all of the diet records, for instance, the nutrition ingestion ratio of carbohydrate ingestion in breakfast time is 20%, the nutrition ingestion ratio of carbohydrate ingestion in lunch time is 24%, the nutrition ingestion ratio of carbohydrate ingestion in tea time is 8%, and the nutrition ingestion ratio of carbohydrate ingestion in dinner time is 48%.

The nutrition ingestion ratio distributing unit 120 calculates the nutrition recommendation Nref according to the nutrition recommended range and the nutrition ingestion ratio. For instance, the nutrition recommended range for daily carbohydrate is 500-750 (g). Therefore, the nutrition recommendation for carbohydrate in breakfast time, in lunch time, in tea time, and in dinner time are 100-150 (g), 120-180 (g), 40-60 (g), and 240-360 (g), respectively. The nutrition recommended range is for example the Dietary Reference Intakes provided by Taiwan Food and Drug Administration, Ministry of Health and Welfare. The nutrition recommended range may be adjusted according to various physical characteristics of different persons, for example, gender, age, weight of the person, or whether the person has disease. Alternatively, the nutrition recommended range may be adjusted by the dietitian or the doctor for particular person.

After the nutrition recommendation for carbohydrate of each dining time period is calculated, the nutrition ingestion abnormality marking unit 130 may select some of the diet records in lunch time from the diet records in lunch time as the selected records. Multiple diet records of a user are listed in Table 1. The diet nutrition converting unit 110 may calculates the nutrition amounts of each of the diet records according to the food nutrition database. For example, the diet nutrition converting unit 110 calculates that the nutrition amounts of carbohydrate corresponding to the first diet record including 6 pieces of chicken nuggets, 1 set of fries, and 1 glass of coke is 270 (g) according to the food nutrition database. And the nutrition amounts of carbohydrate corresponding to each of the diet records are also listed in Table 1.

TABLE 1

| | | nutrition | |
|---|---|---|---|
| eating | | amounts of | |
| time | | carbohydrate | |
| point | food and quantity | (g) | mark |
| 2015 Aug. 1 | 6 pieces of | 270 | abnormal |
| 12:45 | chicken nuggets, | | (exceeding) |
| | 1 set of fries, | | |
| | and 1 glass of coke | | |
| 2015 Aug. 1 | 1 piece of | 113 | abnormal |
| 11:39 | Filet-O-Fish, | | (insufficient) |
| | and 1 glass of coke | | |
| 2015 Aug. 3 | 6 pieces of chicken | 191 | abnormal |
| 12:31 | nuggets, 1 piece of | | (exceeding) |
| | Filet-O-Fish, | | |
| | and 1 glass of coke | | |
| 2015 Aug. 4 | 1 set of fries, 1 piece | 170 | normal |
| 12:05 | of Filet-O-Fish, | | |
| | and 1 glass of coke | | |
| 2015 Aug. 5 | 12 pieces of | 191 | abnormal |
| 12:15 | chicken nugget, | | (exceeding) |
| | and 1 piece of | | |
| | Filet-O-Fish | | |
| 2015 Aug. 6 | 1 sup of corn soup, | 140 | normal |
| 11:55 | 1 piece of Filet-O-Fish, | | |
| | and | | |
| | 1 glass of coke | | |

As listed in Table 1, the diet records in lunch time on August 1 to August 6 of the user are selected, and whether the nutrition amounts of carbohydrate of each selected record is abnormal or not is determined according to the nutrition recommendation for lunch time which is 120-180 (g) as calculated above. For example, as listed in Table 1, the diet record the eating time point of which is at 2015/8/1 12:45, includes 6 pieces of chicken nuggets, 1 set of fries, and 1 glass of coke, and the nutrition amounts of carbohydrate of the diet record at 2015/8/1 12:45 (270 (g)) exceeds the nutrition recommendation for lunch time (120˜180 (g)), and therefore the diet record at 2015/8/1 12:45 is marked as “abnormal (exceeding)”. And the nutrition amounts of carbohydrate corresponding to the diet record the eating time point of which is at 2015/8/2 11:39, includes 1 piece of Filet-O-Fish and 1 glass of coke, and the nutrition amounts of carbohydrate of the diet record at 2015/8/2 11:39 (113 (g)) is lower than the nutrition recommendation for lunch time (120˜180 (g)), and therefore the diet record at 2015/8/2 11:39 is marked as “abnormal (insufficient)”. The other diet records are listed in Table 1, and therefore are not described repeatedly.

Finally, the diet model constructing unit 140 constructs a diet model and marks an abnormal food FER according to the selected records, i.e. the diet records in lunch time on August 1 to August 6 of the user, and whether the nutrition amounts of each selected record is abnormal or not.

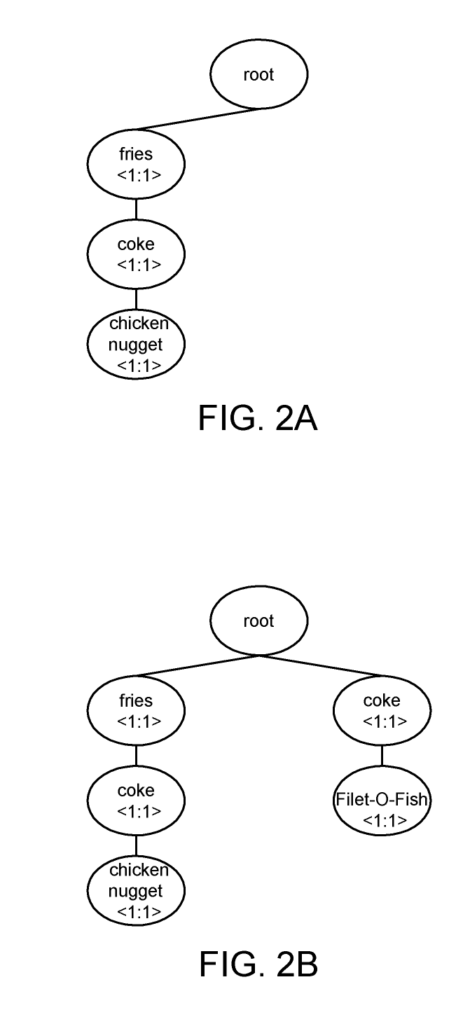

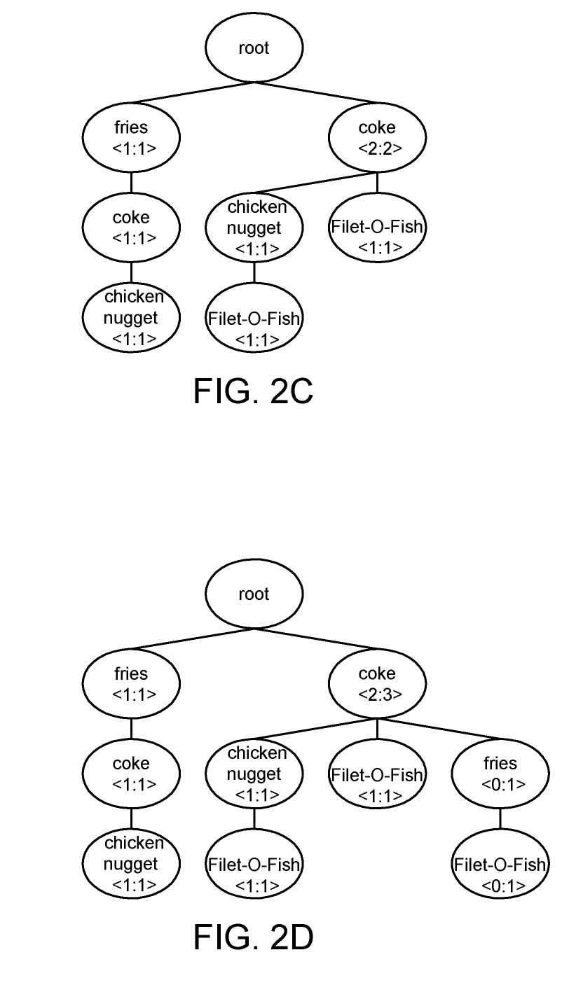

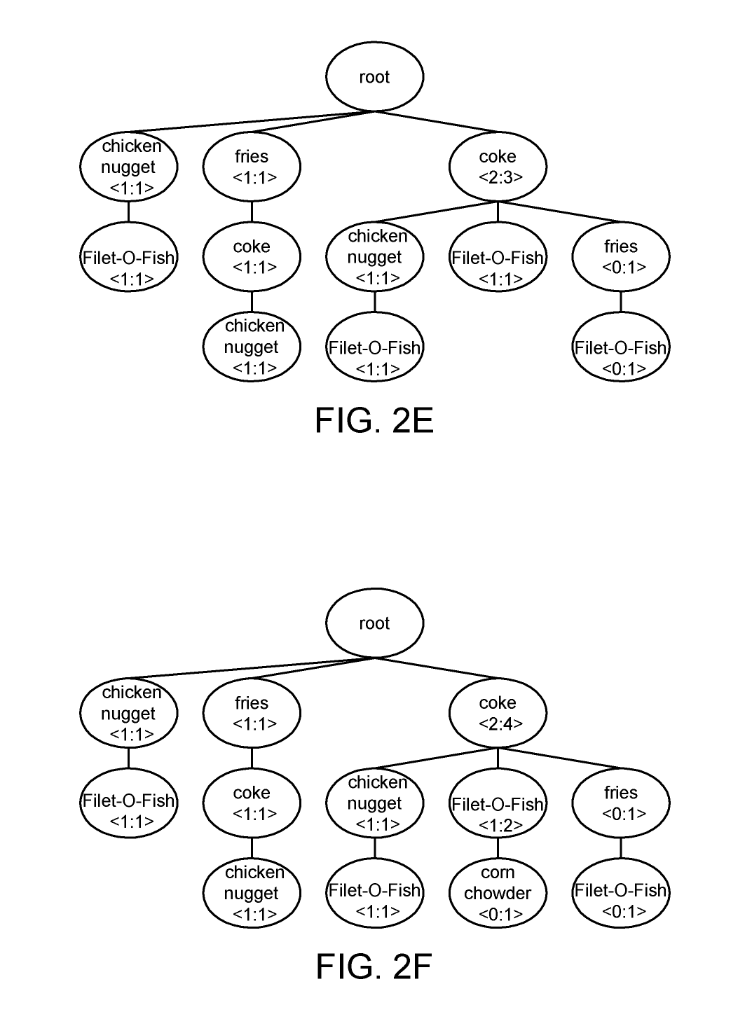

A diet model constructing method is illustrated in detail in an example as below. The diet model constructing method is illustrated with reference to FIGS. 2A to 2F and Table 2 according to the selected records of table 1 of the disclosure. The diet model constructing unit 140 sorts the foods of each of the selected records from more to less according to the nutrition amounts of carbohydrate of the foods. For example, “6 pieces of chicken nuggets, 1 set of fries, and 1 glass of coke” in the diet record at 2015/8/1 12:45 (the diet record in the first row of Table 1) is sorted to be “1 set of fries, 1 glass of coke, and 6 pieces of chicken nuggets” according to the nutrition amounts of carbohydrate. The sorted result of the foods of each of the diet records in Table 1 is listed in Table 2 according to the nutrition amounts of carbohydrate.

TABLE 2

| | | nutrition | |
|---|---|---|---|
| eating | | amounts of | |
| time | food and | carbohydrate | |
| point | quantity | (g) | mark |
| 2015 Aug. 1 | 1 set of fries, | 270 | abnormal |
| 12:45 | 1 glass of | | (exceeding) |
| | coke, and | | |
| | 6 pieces of | | |
| | chicken nuggets | | |
| 2015 Aug. 2 | 1 glass of coke, | 113 | abnormal |
| 11:39 | and 1 piece of | | (insufficient) |
| | Filet-O-Fish | | |
| 2015 Aug. 3 | 1 glass of coke, | 191 | abnormal |
| 12:31 | 1 piece of | | (exceeding) |
| | Filet-O-Fish, | | |
| | and 6 pieces of | | |
| | chicken nuggets | | |
| 2015 Aug. 4 | 1 glass of coke, | 170 | normal |
| 12:05 | 1 set of fries, | | |
| | and 1 piece of | | |
| | Filet-O-Fish | | |
| 2015 Aug. 5 | 12 pieces of | 191 | abnormal |
| 12:15 | chicken nuggets, | | (exceeding) |
| | and 1 piece of | | |
| | Filet-O-Fish | | |
| 2015 Aug. 6 | 1 glass of coke, | 140 | normal |
| 11:55 | 1 piece of | | |
| | Filet-O-Fish, | | |
| | and 1 cup | | |
| | of corn soup | | |

As listed in Table 2, the diet record in the first row is sorted as fries, coke, and chicken nugget according to the nutrition amounts of carbohydrate, and the diet record in the second row is sorted as coke, and Filet-O-Fish. And the sorted result of the diet records in the other rows according to the nutrition amounts of carbohydrate are listed in Table 2, and therefore are not described repeatedly.

And then, the diet model constructing unit 140 constructs a diet model according to the sorted diet records which is sorted according to the nutrition amounts of carbohydrate. The diet model maybe represented by a tree. The diet model constructing method includes the following steps. Firstly, a root node is created. And a path is created for each diet record. When one path is created, whether any child node of the root node of the tree is corresponding to the food having the highest nutrition amounts of carbohydrate is determined. If the answer is yes, the occurrence times of this child node is increased 1 times. If not, a new child node corresponding to this food is created, and the occurrence times of this child node is set as 1. On the other hand, if the nutrition amounts of carbohydrate corresponding to this diet record is abnormal, the abnormal times of this node is increased by 1. And then, whether any child node of this node is corresponding to the food having the second highest nutrition amounts of carbohydrate is determined. If the answer is yes, the occurrence times of this node is increased by 1. If not, a new node is created, and the occurrence times of this node is set as 1. The process is repeated. FIGS. 2A to 2F are schematic diagrams of constructing the diet model according to the diet records of table 2 of the disclosure. FIG. 2A shows the nodes corresponding to the foods of the diet records in the first row of Table 2. As sown in FIG. 2A, the nodes of fries, coke, and chicken nugget are created from the root node from top to down according to the nutrition amounts of carbohydrate. Each node represents the food name, the abnormal times, and the occurrence times. The abnormal times represents the number of times of the diet record are marked as abnormal. The occurrence times represents the number of times the food exists in a diet record. In FIG. 2A, fries, coke, and chicken nugget shows up at the first time in the diet record of the first row of Table 2, and therefore the occurrence times of the fries, coke, and chicken nugget are all marked as 1 times (the right side number of the node). And since the diet record in the first row of Table 2 is marked as abnormal, the abnormal times of the fries, coke, and chicken nugget are all marked as 1 (the left side number of the node). The foods of the diet records in the second row of Table 2 are coke and Filet-O-Fish. And the food having the highest nutrition amounts of carbohydrate in the second row of Table 2 is coke, which is different from the highest carbohydrate amount of the diet record in the first row of Table 2, i.e. fries, and therefore a new child node of the root node is created corresponding to the coke as shown in FIG. 2B. And the child node of coke is created corresponding to the lower nutrition amounts of carbohydrate in the second row of Table 2, i.e. node of Filet-O-Fish. In this diet record, the occurrence times of the nodes of coke and Filet-O-Fish are both marked as 1, and the abnormal times of the nodes of coke and Filet-O-Fish are both marked as 1 since the diet record is also marked as abnormal.

As shown in FIG. 2C, the tree is continuously constructed according to the diet record in the third row of Table 2. The food having the highest nutrition amounts of carbohydrate in the third row of Table 2 is coke, which is the same as that in the second row of Table 2, and therefore there is a child node of the root node corresponding to the coke and no new child node is needed to be created, and the occurrence times and the abnormal times are accumulated at the existing node. Thus, the occurrence times of the node of coke is added up to be 2, and the abnormal times of the node of coke is also added up to be 2 since this diet record is also marked as abnormal. And the food having the second highest nutrition amounts of carbohydrate in the third row of Table 2 is chicken nugget, which is different from that in the second row of Table 2, i.e. Filet-O-Fish, and therefore a new child node of the coke node is created corresponding to the chicken nugget, and another new child node of the chicken nugget is created corresponding to the Filet-O-Fish. The occurrence times of the nodes of chicken nugget and Filet-O-Fish are both marked as 1, and the abnormal times of the nodes of chicken nugget node and Filet-O-Fish are both marked as 1 since this diet record is also marked as abnormal.

FIG. 2D shows the tree constructed according to the diet record in the fourth row of Table 2. Similarly, the food is sorted as coke, fries, and Filet-O-Fish according to the nutrition amounts of carbohydrate, and a new path is constructed accordingly. Since this diet record is marked as normal, the abnormal times of the nodes of fries and Filet-O-Fish are both marked as 0, and the abnormal times of the node of coke remains at 2 and the occurrence times of the node of coke is added up to be 3.

And the tree is continually constructed as shown in FIG. 2E according to the diet record in the fifth row of Table 2. And then finally, the tree is continually constructed as shown in FIG. 2F according to the diet record in the sixth row of Table 2. And FIG. 2F shows the completed tree according to all of the selected records. The node in the upper level represents that the food has higher nutrition amounts of carbohydrate. And as shown in FIG. 2F, the nodes at top level are chicken nugget, fries, and coke, and the occurrence times of the node of coke is 4, and the abnormal times of the node of coke is 2. That is, there are 4 diet records in which the food of highest nutrition amounts of carbohydrate is coke, and 2 of those 4 diet records are marked as abnormal. Therefore, as shown in FIG. 2F, coke is the major factor of the abnormal nutrition amounts of carbohydrate in lunch time. And the coke is marked as the abnormal food of lunch time by the diet model constructing unit 140. After the user learns that the coke is marked as the abnormal food, the quantity of coke may be adjusted or the coke may be replaced with other food. In this embodiment, the diet model is constructed according to the nutrition amounts of carbohydrate in lunch time. However, in other embodiments, the diet model may be constructed according to the nutrition amounts of other types of nutrition or according to the diet records in other time period. The diet model is constructed corresponding to personal eating time periods and personal diet records, and the diet model may be analyzed and an abnormal food may be marked according to the nutrition recommendation for personal dining time periods. The diet model may be provided for a dietitian or a doctor to give advice of personal dietary recommendation for different person and various eating habits accordingly.

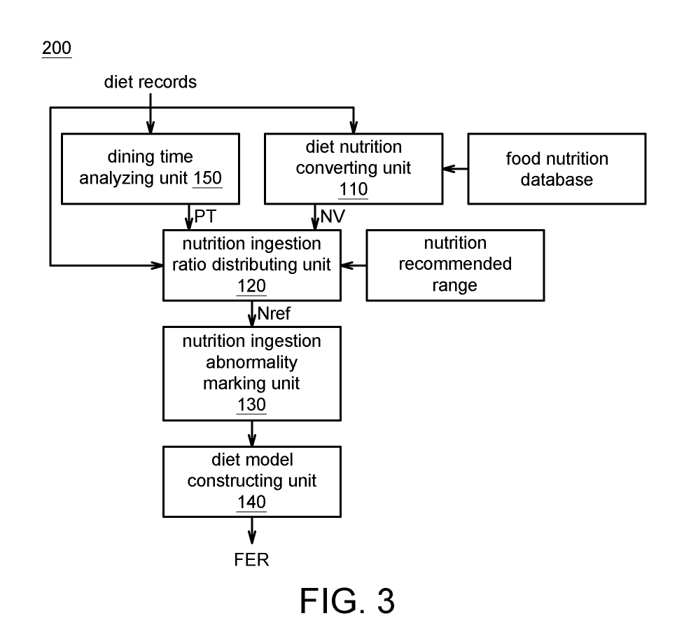

Please refer to FIG. 3. FIG. 3 is a block diagram of a diet ingestion analyzing system 200 according to another embodiment of the disclosure. The diet ingestion analyzing system 200 differs from the diet ingestion analyzing system 100 shown in FIG. 1 is that the diet ingestion analyzing system 200 further includes a dining time analyzing unit 150. The time analyzing unit 150 obtains a plurality of dining time periods according to the eating time points of the diet records, and the dining time analyzing unit 150 further decides a specific time PT according to the dining time periods.

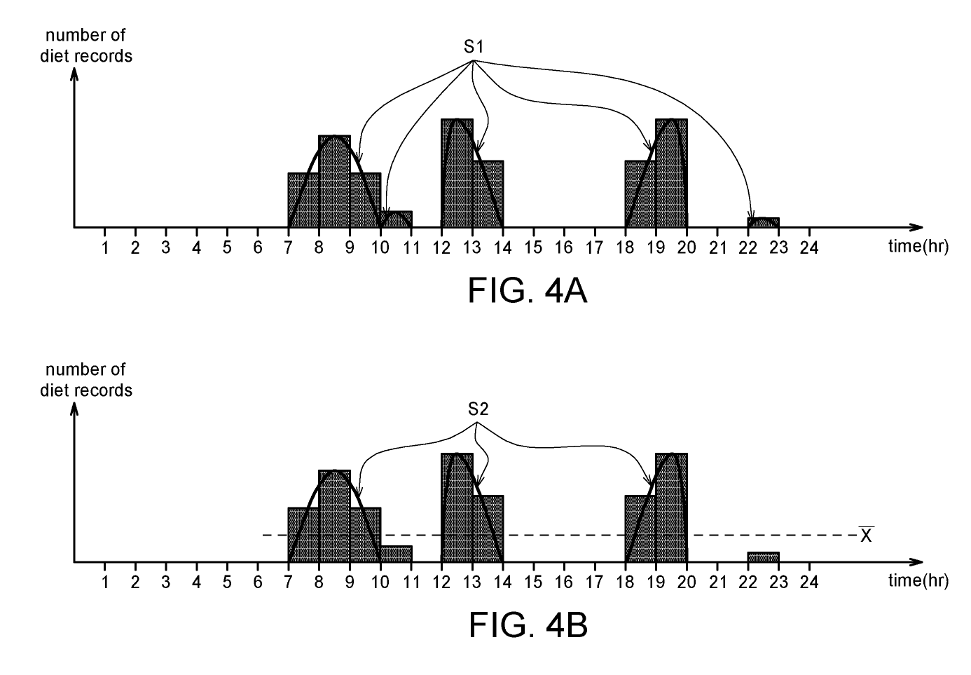

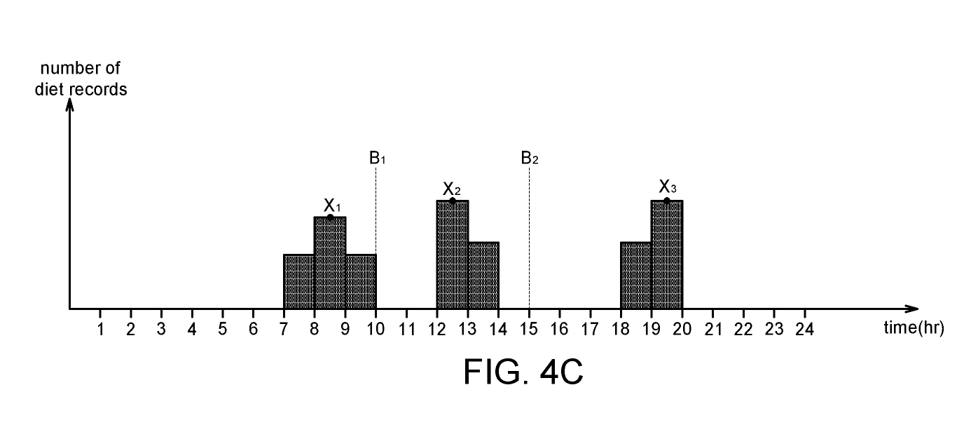

Please refer to FIGS. 4A and 4B for illustrating an example for deciding a specific time by the dining time analyzing unit 150. FIGS. 4A and 4B are schematic diagram of an example for deciding the dining time periods according to a number of the diet records in each hour. The dining time analyzing unit 150 sorts the eating time points and classifies the eating time points to a plurality of unit time periods, e.g. 24 hours, to obtain a plurality of unit time diet records each of which corresponds to each of the unit time periods and a number of the diet records in each hour is accumulated accordingly. However, the disclosure is not limited thereto. A number of the diet records may be accumulated for every half hour, or every two hours, etc. As shown in FIG. 4A, S1 is a wave set of the diet record. Afterwards, the dining time analyzing unit 150 calculates an average X̅of the numbers of the diet records in each hour, as shown in FIG. 4B, and S2 is a wave set of the diet records whose number is greater than the average X̅. In an embodiment, each of the dining time periods is decided according to the wave set S2 including some of the unit time periods which are adjacent and in each of which the number of the diet records is greater than the average X̅. For example, 7:00-9:00 is determined as the breakfast time, 12:00-13:00 is determined as the lunch time, and 18:00-19:00 is determined as the dinner time. After each of the dining time periods is determined, the dining time analyzing unit 150 may select one of the dining time periods as the specific time PT. And then, the nutrition ingestion ratio distributing unit 120 generates the nutrition recommendation in the specific time according to the specific diet records. And the nutrition ingestion abnormality marking unit 130 also determines whether each of the nutrition amounts of the selected records is abnormal or not according to the specific diet records and the nutrition recommendation in the specific time.

In another embodiment, FIG. 4C shows a schematic diagram of another example for deciding the specific time according to the diet records in each hour. In this embodiment, a plurality of dinning time range is decided according to the some of the unit time periods which are adjacent and in each of which the number of the diet records is greater than the average X̅. In the dining time periods, the unit time period X₁, X₂, or X₃ respectively has a highest number of the diet records. The boundary between the two dining time range, as shown in the dashed line of FIG. 4C, may be determined as (Xᵢ+Xᵢ₊₁)/2, where Xₗ is the hour of each dinning time having the highest number of diet record, i is a positive integer. For example, 7:00-9:00 is determined as the breakfast time, 12:00-13:00 is determined as the lunch time, and 18:00-19:00 is determined as the dinner time. The hour having the highest number of the diet records of each dining time period is shown in dots of FIG. 4C. For example, the unit time period X₁ having the highest number of the diet records in breakfast time is 8:00, the unit time period X₂ having the highest number of the diet records in lunch time is 12:00, and the unit time period X₃ having the highest number of the diet records in dinner time is 19:00. In this embodiment, the specific time is decided according to the unit time period having the highest number of the diet records, for instance, the boundary between breakfast time and lunch time is decided as 10:00, as shown in the dashed line B₁ of FIG. 4C. And the boundary between lunch time and dinner time is decided as 15:00, as shown in the dashed line B₂ of FIG. 4C. Thus, a day is divided into three time periods, 0:00-09:59, 10:00-14:59, and 15:00-23:59. And the dining time analyzing unit 150 may choose one of the three time periods as the specific time.

Therefore, in this embodiment, the dining time analyzing unit 150 may analyze the eating time points of the diet records of different users to obtain the personal eating time wave set, and then obtains personal dining time periods according to eating habits for each person. As a result, the diet ingestion analyzing system in the disclosure may determine the nutrition ingestion ratio and the nutrition recommendation of each dining time period by the nutrition ingestion ratio distributing unit 120 according to the eating habits for each person. The nutrition ingestion abnormality marking unit 130 also determines whether each of the nutrition amounts of the specific diet records is abnormal or not according to the specific diet records and the nutrition recommendation in the specific time.

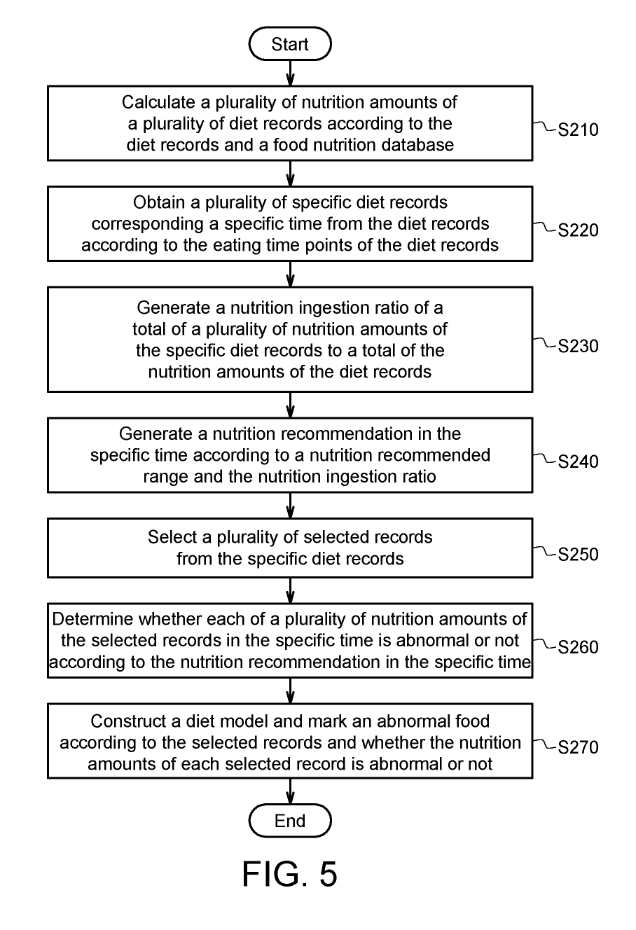

A diet ingestion analyzing method is provided in the disclosure. Please refer to FIG. 5. FIG. 5 is a flowchart of a diet ingestion analyzing method. Firstly, the method starts at step S210. A plurality of nutrition amounts of a plurality of diet records are calculated according to the diet records and a food nutrition database. And then step S220 is performed. A plurality of specific diet records corresponding a specific time is obtained from the diet records according to the eating time points of the diet records. And after step S220 is performed, the step S230 is performed. A nutrition ingestion ratio of a total of a plurality of nutrition amounts of the specific diet records to a total of the nutrition amounts of the diet records is generated. And then the step S240 is performed. A nutrition recommendation in the specific time is generated according to a nutrition recommended range and the nutrition ingestion ratio. Afterwards, the step S250 is performed. A plurality of selected records are selected from the specific diet records. And after step S250 is performed, the step S260 is performed. Each of a plurality of nutrition amounts of the selected records in the specific time is determined abnormal or not according to the nutrition recommendation in the specific time. And finally, the step S270 is performed. A diet model is constructed and an abnormal food is marked according to the selected records and whether the nutrition amounts of each selected record is abnormal or not.

According to the diet ingestion analyzing systems and the diet ingestion analyzing methods disclosed in above embodiments, a proper nutrition ingestion ratio of a time period is provided by analyzing the personal eating time periods and personal diet records, and a personal diet model is constructed and an abnormal food is marked according to the recommendation of each of the personal dining time periods for personal eating habits. The diet ingestion analyzing systems and methods thereof in the disclosure may be adjusted according to personal eating habits and an abnormal food the nutrition amounts of which exceeds the nutrition recommendation may be obtained. On the other hand, each of the dining time periods is adjusted and a nutrition ingestion ratio for each of the dining time periods is analyzed according to personal eating habits, and the recommendation of each of the dining time periods is calculated and whether the nutrition amounts of the diet records is abnormal or not is determined according to personal eating habits. The above diet ingestion analyzing system and the diet ingestion analyzing method may quickly analyze personal diet records to find the abnormal food, and therefore it is easy and convenient for finding the abnormal food of each of the dining time periods. And the diet ingestion analyzing system and the diet ingestion analyzing method may be adjusted according to eating habits of different users for the user to observe the personal eating type.

The disclosure is to explore a dietary dynamic time section of a user by recording the eating time point, and to obtain a nutrition ingestion ratio for each time section, and to distribute nutrition recommendation for each time section according to a daily nutrition recommendation provided by a dietary reference intakes database and the nutrition ingestion ratio for each time section. The disclosure is not limited to provide a fixed amount of nutrition recommendation for three meals each day.

The disclosure is to analyze the dietary information of the user, and to establish a structure of incremental properties and frequency of ingestion food, and then mark the abnormal ingestion frequent pattern by analyzing actual data, which is different from the traditional way which is analyzed purely manual by the dietitian or the doctor according to the paper record or the electronic record.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A diet ingestion analyzing system, comprising:
a diet nutrition converting unit for calculating a plurality of nutrition amounts of a plurality of diet records according to the diet records and a food nutrition database, wherein each of the diet records comprises a eating time point, a food and a quantity of the food;
a nutrition ingestion ratio distributing unit for obtaining a plurality of specific diet records corresponding a specific time from the diet records according to the eating time points of the diet records, for generating a nutrition ingestion ratio of a total of a plurality of nutrition amounts of the specific diet records to a total of the nutrition amounts of the diet records, and for generating a nutrition recommendation according to a nutrition recommended range and the nutrition ingestion ratio;
an nutrition ingestion abnormality marking unit for selecting a plurality of selected records from the specific diet records, and for determining whether each of a plurality of nutrition amounts of the selected records is abnormal or not according to the nutrition recommendation; and
a diet model constructing unit for constructing a diet model and marking an abnormal food according to the selected records and whether the nutrition amounts of each of the selected records is abnormal or not.

2. The diet ingestion analyzing system according to claim 1, wherein the diet nutrition converting unit further calculates the nutrition amounts of each of the foods according to the food nutrition database, the food and the quantity of the food, and the diet nutrition converting unit further calculates the nutrition amounts of each of the diet records according to the nutrition amounts of each of the foods.

3. The diet ingestion analyzing system according to claim 1, further comprising:
a dining time analyzing unit for obtaining a plurality of dining time periods according to the eating time points of the diet records and for deciding the specific time according to the dining time periods.

4. The diet ingestion analyzing system according to claim 3, wherein
the dining time analyzing unit further sorts the eating time points and classifies the eating time points to a plurality of unit time periods, accumulates a number of the diet records in each of the unit time periods, calculates an average of the numbers of the diet records in the unit time periods, and determines whether the number of the diet records in each of the unit time periods is greater than the average or not; and
each of the dining time periods comprises some of the unit time periods which are adjacent and in each of which the number of the diet records is greater than the average, and the dining time analyzing unit further selects one of the dining time periods as the specific time.

5. The diet ingestion analyzing system according to claim 3, wherein
the dining time analyzing unit further sorts the eating time points and classifies the eating time points to a plurality of unit time periods, accumulates a number of the diet records in each of the unit time periods, calculates an average of the numbers of the diet records in the unit time periods, and determines whether the number of the diet records in each of the unit time periods is greater than the average or not; and
each of the dining time periods comprises some of the unit time periods which are adjacent and in each of which the number of the diet records is greater than the average; in each of the dining time periods, one of the unit time periods has a highest number of the diet records; and the dining time analyzing unit further decides the specific time according to the unit time periods having the highest number of the diet records.

6. The diet ingestion analyzing system according to claim 1, wherein the nutrition ingestion ratio distributing g unit further calculates a trimmed mean of the nutrition amounts of the specific diet records, calculates a trimmed mean of the nutrition amounts of the diet records, and obtains the nutrition ingestion ratio by dividing the trimmed mean of the nutrition amounts of the specific diet records and the trimmed mean of the nutrition amounts of the diet records.

7. The diet ingestion analyzing system according to claim 1, wherein each of the selected records comprises a plurality of foods, and the diet model constructing unit further sorts the foods of each of the selected records according to the nutrition amounts of the foods, and marks at least one of the foods as the abnormal food according to a number of the selected records whose nutrition amounts are determined to be abnormal and an occurrence times of the each of the foods in the selected records.

8. A diet ingestion analyzing method, comprising:
calculating a plurality of nutrition amounts of a plurality of diet records according to the diet records and a food nutrition database, wherein each of the diet records comprises a eating time point, a food and a quantity of the food;
obtaining a plurality of specific diet records corresponding a specific time from the diet records according to the eating time points of the diet records;
generating a nutrition ingestion ratio of a total of a plurality of nutrition amounts of the specific diet records to a total of the nutrition amounts of the diet records;
generating a nutrition recommendation according to a nutrition recommended range and the nutrition ingestion ratio;
selecting a plurality of selected records from the specific diet records;
determining whether each of a plurality of nutrition amounts of the selected records is abnormal or not according to the nutrition recommendation; and
constructing a diet model and marking an abnormal food according to the selected records and whether the nutrition amounts of each of the selected records is abnormal or not.

9. The diet ingestion analyzing method according to claim 8, wherein the step of calculating the nutrition amounts of the diet records according to the food nutrition database comprises:
calculating the nutrition amounts of each of the foods according to the food nutrition database, the food and the quantity of the food; and
calculating the nutrition amounts of each of the diet records according to the nutrition amounts of each of the foods.

10. The diet ingestion analyzing method according to claim 8, further comprising:
obtaining a plurality of dining time periods according to the eating time points of the diet records and deciding the specific time according to the dining time periods.

11. The diet ingestion analyzing method according to claim 10, further comprising:
sorting the eating time points and classifying the time points to a plurality of unit time periods;
accumulating a number of the diet records in each of the unit time periods;
calculating an average of the numbers of the diet records in the unit time periods; and
determining whether the number of the diet records in each of the unit time periods is greater than the average or not;
wherein each of the dining time periods comprises some of the unit time periods which are adjacent and in each of which the number of the diet records is greater than the average, and the specific time is selected from one of the dining time periods.

12. The diet ingestion analyzing method according to claim 10, further comprising:
sorting the eating time points and classifying the time points to a plurality of unit time periods;
accumulating a number of the diet records in each of the unit time periods;
calculating an average of the numbers of the diet records in the unit time periods; and
determining whether the number of the diet records in each of the unit time periods is greater than the average or not;
wherein each of the dining time periods comprises some of the unit time periods which are adjacent and in each of which the number of the diet records is greater than the average; in each of the dining time periods, one of the unit time periods has a highest number of the diet records; and the specific time is decided according to the specific time according to the unit time periods having the highest number of diet records.

13. The diet ingestion analyzing method according to claim 8, wherein the steps of generating the nutrition ingestion ratio and generating the nutrition recommendation comprise:
calculating a trimmed mean of the nutrition amounts of the specific diet records, and calculating a trimmed mean of the nutrition amounts of the diet records; and
obtaining the nutrition ingestion ratio by dividing the trimmed mean of the nutrition amounts of the specific diet records and the trimmed mean of the nutrition amounts of the diet records.

14. The diet ingestion analyzing method according to claim 8, wherein each of the selected records comprises a plurality of foods, and the step of constructing the diet model comprises:
sorting the foods of each of the selected records according to the nutrition amounts of the foods; and
marking at least one of the foods as the abnormal food according to a number of the selected records whose nutrition amounts are determined to be abnormal and an occurrence times of the each of the foods in the selected records.
